(19) United States
(12) Patent Application Publication
(10) Pub. No.: US 2002/0119810 A1
(43) Pub. Date: Aug. 29, 2002

(54) Program execution system comprising program execution device, operational device and display device

(76) Inventors: Susumu Takatsuka, Tokyo (JP); Satoru Miyaki, Tokyo (JP); Shingo Matsumoto, Tokyo (JP)

Correspondence Address: KATTEN MUCHIN ZAVIS ROSENMAN, 575 MADISON AVENUE, NEW YORK, NY, 10022-2585, US

(21) Appl. No.: 10/046,669

(22) Filed: Jan. 17, 2002

(30) Foreign Application Priority Data
Jan. 24, 2001 (JP) 2001-016234

(51) Int. Cl. A63F 13/00

(52) U.S. Cl. 463/7

(57) ABSTRACT

In the present invention, the user can display an appearance selection screen, select an appearance of a game character to be raised, and confirm movement of the game character having a selected appearance. The user then displays a language setting screen to make setting of a conversation language spoken by the game character. Thus the user can set by himself or herself basic parameters (appearance, personality, etc.) of the game character to be raised, so that the user can enjoy various raising patterns even if the same character is used.

### CROSS REFERENCE TO RELATED APPLICATION

This application is related to Japanese Patent Application No. 2001-16234 filed on Jan. 24, 2001, based on which this application claims priority under the Paris Convention and the content of which is incorporated herein by reference.

### BACKGROUND OF THE INVENTION

1. Field of the Invention

The present invention relates to a recording medium having recorded therein a program and data used on a program execution system which comprises a program execution device, an operational device and a display device; the game program per se; such program execution system; and such program execution device.

2. Description of the Related Art

There is known an information instrument (entertainment system) such as an entertainment device including a video game machine, with which the user can display, on a screen of a television image receiver, game contents stored in a recording medium such as CD-ROM and enjoy the game through operation with an operational device.

In such entertainment system, the entertainment device and the operational device are generally connected with a serial interface, through which clock signals are sent from the entertainment device, and in synchronous to such clock signals, key switch information corresponded to operation by the user (game player, for example) is sent from the operational device.

Recently, there is developed a system having provided therein a vibration generation means for applying vibration to the user as requested from the external (e.g., entertainment system), so as to allow the system to give various types of vibration to the user in response to the user's operation in progress of games, which has already been put into practical use.

More recently, there is proposed and marketed a video game such that allowing the user to raise game characters displayed on a monitor (simply referred to as “raising game” hereinafter).

In such raising game, the user could only select, from a plurality of game characters, an arbitrary game character which he or she wants to raise, and could not set basic parameters (e.g., appearance, personality) of the characters to be raised.

Thus there has been a problem that the growing process of a certain game character would be almost the same unless otherwise extreme environmental setting or growing condition is provided, which ruins attractive nature of such game.

The conventional raising game is also characterized in that the raising can only enhance the personal ability of the game character, which is typified by the speed-up of the characters motion, growth into a larger body, and gain to a higher level.

So that the user's attempts to enjoy various growth processes by varying the raising way only resulted in changes in the improvement ratio of the ability, where the raising pattern per se remains unchanged, which is causative of loosing interest of the user.

### SUMMARY OF THE INVENTION

The present invention was proposed to address the foregoing problem, and an object thereof resides in that providing a program, recording medium storing such program; program execution system and such program execution device, all of which allow the user to set basic parameters (e.g., appearance, personality) of the game characters to be raised and to enjoy various raising patterns even with the same game character.

It is another object of the present invention to provide a program, recording medium storing such program; program execution system and such program execution device, all of which allow the user to enjoy, not only changes in a ratio of ability improvement, but also an unprecedented raising pattern in which a game character can become a good or bad fellow depending on the raising way.

The present invention is characterized in that generating game characters based on parameters related at least to the appearance and personality of game characters, where such parameters can be entered according to operational instructions of the user. This allows the user to define by himself or herself basic parameters (appearance, personality, etc.) of the game character to be raised, and to enjoy various raising patterns even if the same game character is to be raised.

Other and further objects and features of the present invention will become obvious upon understanding of the illustrative embodiments about to be described in connection with the accompanying drawings or will be indicated in the appended claims, and various advantages not referred to herein will occur to one skilled in the art upon employing of the invention in practice.

### BRIEF DESCRIPTION OF THE DRAWINGS

FIG. 1 is a schematic drawing showing an entertainment system of an embodiment according to the present invention;

FIG. 2 is a block diagram showing a circuit constitution of the entertainment device according to the present embodiment;

FIG. 3 is a drawing of the exemplary game characters thus generated;

FIG. 4 is a flow chart showing character generation processing:

FIG. 5 is an exemplary drawing showing an appearance selection screen;

FIG. 6 is an exemplary drawing showing a language selection screen;

FIG. 7 is an exemplary drawing showing a personality setting screen;

FIG. 8 is a flow chart showing a process flow of character's conversation in a set language;

FIG. 9 is an illustration of an exemplary good fellow character;

FIG. 10 is an illustration of an exemplary bad fellow character;

FIG. 11 is an illustration of an exemplary conduct of the bad fellow character;

FIG. 12 is a first flow chart showing conducts of a generated game character varying in response to the user's correspondence;

FIG. 13 is a second flow chart showing conducts of a generated game character varying in response to the user's correspondence;

FIG. 14 is a flow chart showing a display processing of game character's motion;

FIG. 15 is a flow chart showing a processing for game character's marriage;

FIG. 16 is an illustration showing a flashing display of a game character that attained a marriageable age;

FIG. 17 is an illustration showing a scene of a premarital interview;

FIG. 18 is an illustration showing a scene in which a game character to be married is selected; and

FIG. 19 is an illustration showing a scene in which an egg brakes and an upgraded game character is born.

### DETAILED DESCRIPTION OF THE PREFERRED EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

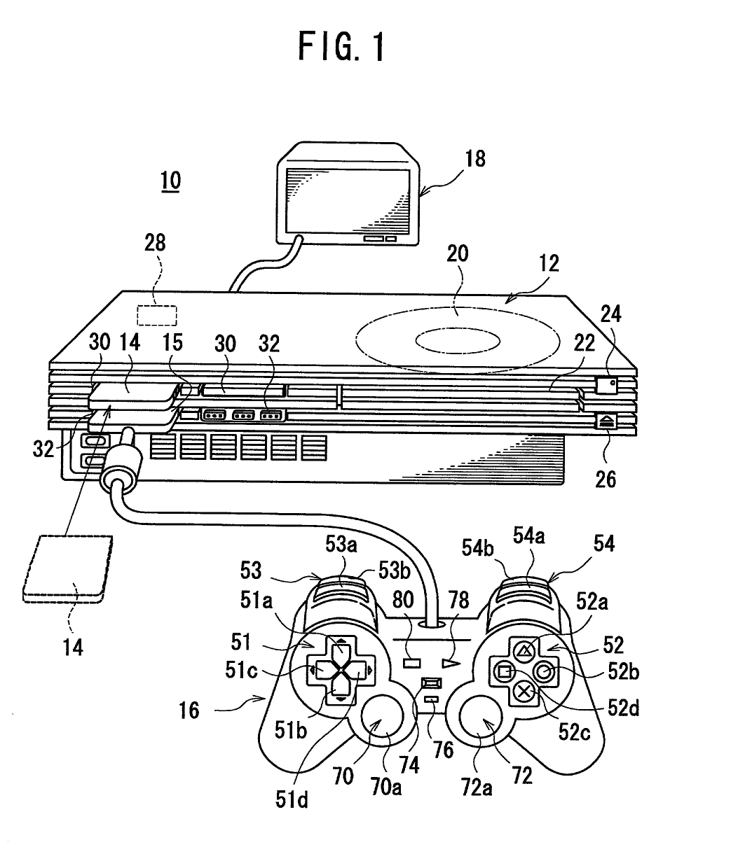

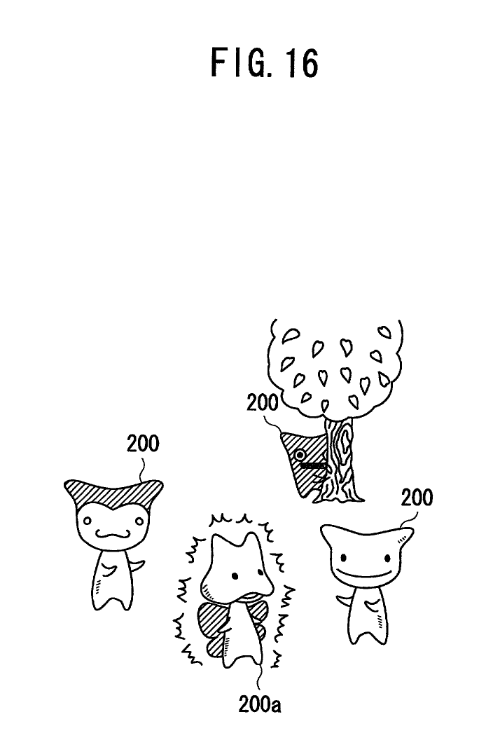

The following paragraphs describe embodiments of the program execution system and program execution device of the present invention applied to an entertainment system, and embodiments of the recording medium and program of the present invention applied to a recording medium, having stored therein programs and data, and a program used by the foregoing entertainment system, referring to FIGS. 1 to 19.

An entertainment system 10 according to the present embodiment basically comprises, as shown in FIG. 1, an entertainment device 12 on which various computer programs are executed, a memory card 14 readily detachable to such entertainment device 12, a controller 16 readily detachable to such entertainment device 12, and a monitor (display) 18 that is a display device such as a television receiver to which image and sound signals are sent from the entertainment device 12.

The entertainment device 12 is designed to read computer programs out from a large-capacity recording medium such as an optical disk 20, for example, CD-ROM or DVD-ROM, and to execute games or the like as being instructed by the user (e.g., game player). Execution of the game in this context now refers to navigating progress of the game while controlling display on the monitor 18 and sound mainly by receiving input through a connector 15 from the controller 16.

As shown in FIG. 1, the entertainment device 12 is shaped in a stack of flat rectangular parallelepipeds, and the front panel thereof has provided thereon a disk tray 22 which is a disk loading section reciprocally movable forward and backward, and is provided for loading thereon an optical disk 20 as a recording medium storing computer programs or the relevant data; a reset switch 24 for arbitrarily resetting a currently-running computer program or so; an open button 26 for drawing the disk tray 22; two plug-in sockets 30 for the memory card 14; and two controller terminals 32 to which the connectors 15 of the controllers 16 can be inserted. The rear panel thereof has provided thereon a power switch 28; and an AV (audio-visual) multi-output terminal, not shown, that is an image and sound output terminal to which the monitor 18 is connected through an AV cable.

The entertainment device 12 not only exhibits a control function such that reading a computer program out from the optical disk 20, which is a recording medium such as a CD-ROM and DVD-ROM having stored therein computer programs and data of computer games (video games), and executing such program to thereby display game characters and scenes on the monitor 18, but also internally has various control functions such as those for reproducing movie from DVD (digital versatile disk) or music from CDDA (compact dick digital audio), which are other types of the optical disk 20. It still also has a function of executing a computer program downloaded by communication typically through a communication network. During execution of a computer program for video game, three-dimensional computer graphic images generated by the entertainment device 12 are displayed on the monitor 18 as a display device.

In such case, also signals sent from the controller 16 are processed by one of the foregoing functions of the entertainment device 12, and results of the processing are seeable as motions of the game characters, change of the scenes and so forth on the monitor 18.

The controller 16 has a first operational portion 51 and a second operational portion 52 on the left and right sides, respectively, from the center on the top plane thereof, has a third operational portion 53 and a fourth operational portion 54 on the lateral plane thereof, and has a left joy stick 70 and a right joy stick 72 for effecting analog operation on the front left and front right sides, respectively, on the top plane thereof.

The first operational portion 51 serves as a press operational portion for adding motion to the game characters or the like displayed typically on the screen of the monitor 18, whose functions are set typically by a computer program stored in the optical disk 20, and has four operational keys (directional keys) 51a, 51b, 51c and 51d for moving the game characters or the like upward, downward, leftward and rightward. The directional key 51a is also referred to as an upward key, the directional key 51b as a downward key, the directional key 51c as a leftward key, and the directional key 51d as a rightward key.

The second operational portion 52 has four cylindrical operational buttons 52a, 52b, 52c and 52d, the individual of which have on the top portion thereof identification marks of “Δ”, “∘”, “×” and “□”, respectively. The individual operational buttons 52a, 52b, 52c and 52d are also referred to as Δ button 52a, ∘ button 52b, × button 52c and □ button 52d, respectively.

The individual operational buttons 52a to 52d in the second operational portion 52 are assigned with the individual functions by a computer program stored in the optical disk 20, where the functions of the individual operational buttons 52a to 52d are such that those for moving the left arm, right arm, left leg and right leg, respectively, of a game character or the like.

The third and fourth operational portions 53 and 54 have almost similar configuration, in which vertically aligned are two operational buttons of an L1 button 53a and an L2 button 53b, and two operational buttons of an R1 button 54a and an R2 button 54b, respectively. Also such third and fourth operational portions 53 and 54 are assigned with functions by a computer program stored in the optical disk 20, which are typically those making the game characters to perform specific motions.

The left and right joy sticks 70 and 72 are respectively provided with a signal input element which typically comprises a variable resister rotatable 360° around an axis of operation. Such left and right joy sticks 70 and 72 are designed to output analog values corresponding to the amount of inclinational operation thereof, and to return back to the individual neutral positions when released as being energized by elastic members not shown. The left and right joy sticks 70 and 72 can also output other signals when being pressed down, where such signals differ from the analog values output in association to the inclinational operation. That is, the left and right joy sticks 70 and 72 have functions of an L3 button 70a and R3 button 72a, which can be assumed as a fifth and sixth operational portions.

By rotating and inclining the left and right joy sticks 70 and 72, the user can enter instruction signals for effecting analog motions, such as typically moving the characters while rotating them, moving them while varying the speed, and changing the status thereof.

The left and right joy sticks 70 and 72 shown in FIG. 1 are available by being switched from the first and second operational portions 51 and 52. The switching can be effected by using an analog mode switch 74. By selecting the left and right joy sticks 70 and 72 using such analog mode switch 74, an indicator 76 lights on to thereby inform the user of the selection of such left and right joy sticks 70 and 72.

The controller 16 is also provided with a start button (start switch) 78 for prompting start of games or the like, and a selection button 80 (selection switch) for selecting difficulty level of games at the start thereof.

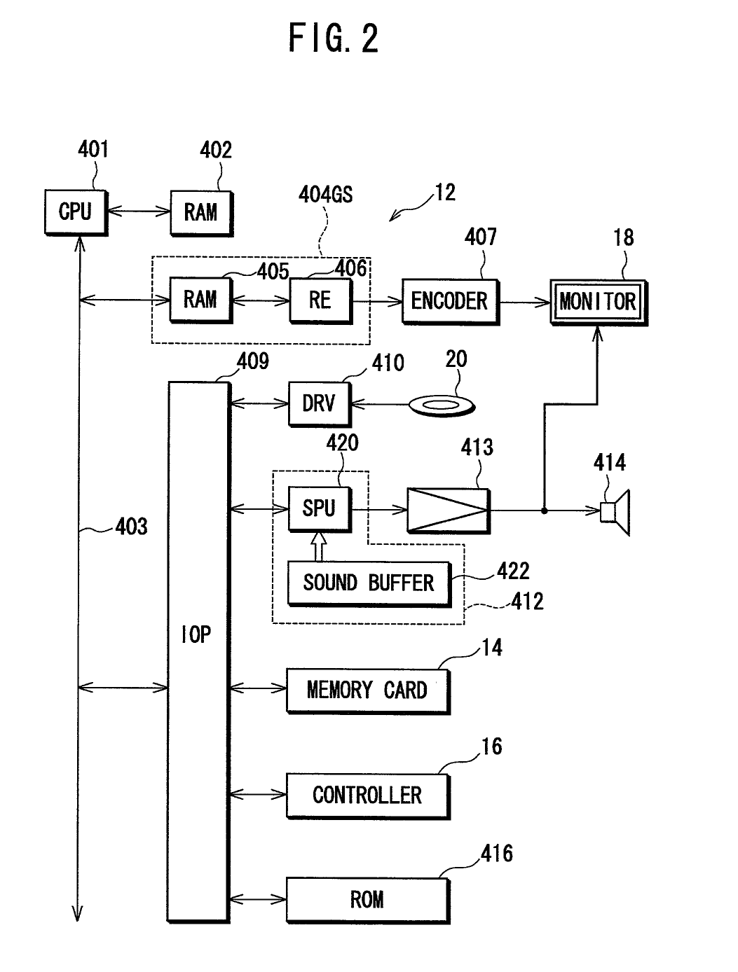

The internal configuration and general operation of the entertainment device 12 shown in FIG. 1 will be explained referring to the block diagram in FIG. 2.

In the entertainment device 12, a RAM 402 as a semiconductor memory and a bus 403 are connected to a CPU 401 for controlling such entertainment device 12.

To the bus 403, a graphic synthesizer (GS) 404 and an input/output processor (IOP) 409 are respectively connected. The GS 404 includes an RAM (image memory) 405 containing therein a frame buffer, a Z buffer and a texture memory, and a rendering engine 406 having a rendering function including a drawing function of drawing into a frame buffer of the image memory 405.

To thus-composed GS 404, a monitor 18 as an external device is connected through, for example, an encoder 407 which is responsible for converting digital RGB signals or so to NTSC standard television signals.

To the IOP 409, connected are a driver 410 for reproducing and decoding data recorded in the optical disk 20, a sound producing system 412, a memory card 14 as an external memory comprising a flash memory, the controller 16, and an ROM 416 having recorded therein an operating system and the like. The sound producing system 412 is connected through an amplifier 413 to a speaker 414 and the monitor 18 as the external devices to thereby supply sound signals.

The sound producing system 412 has a sound processing unit (SPU) 420 for generating music sound and effective sound in accordance with the instruction made by the CPU 401, and a sound buffer 422 for storing such music sound and effective sound generated from the SPU 420. The music signal and effective sound signals generated from the SPU 420 are supplied to an audio terminal of the speaker 414 or monitor 18, and are then emitted from such speaker 414 and monitor 18 as music sound and effective sound.

The SPU 420 is provided with an ADPCM (adaptive differential PCM) decoding function for reproducing sound data which was obtained after processing 16-bit sound data as 4-bit differential signals by adaptive differential PCM, a reproduction function for reproducing waveform data stored in the sound buffer 422 to thereby emit effective sound or the like, and a modulation function for modulating and reproducing waveform data stored in the sound buffer 422.

Being provided with such functions, the sound producing system 412 is available as a so-called sampling sound source which emits musical sound and effective sound based on the waveform data recorded in the sound buffer 422 while being instructed by the CPU 401.

The memory card 14 is a card-type external memory device typically comprising a CPU, or a gate array with a flash memory, and designed to be readily attachable or detachable to or from the entertainment device 12 through a socket 30 provided thereon so as to store intermediate status of the game or a program for reproducing DVDs.

The controller 16 is a device for giving instruction (binary instruction or many valued instruction) to the entertainment device 12 upon being pressed on a plurality of buttons provided thereon. The driver 410 is provided with a decoder for decoding images encoded based on MPEG (moving picture experts group).

Next paragraphs will describe how images are displayed on the monitor 18 while being controlled through the controller 16. The following description stands on the basis that object data comprising polygon apex data, texture data, etc. stored in the optical disk 20 are already readout through the driver 410 and stored into the RAM 402 in the CPU 401.

When a user's instruction is entered through the controller 16 to the entertainment device 12, the CPU 401 calculates a three-dimensional position of an object and an orientation thereof relative to a viewpoint based on such instruction. This alters polygon apex data of the object defined by a (X, Y, Z) coordinate value in an orthogonal tri-axial system. The altered polygon apex data are converted by transparent conversion into two-dimensional coordinate data.

An area specified by the two-dimensional coordinate is a so-called polygon. The two-dimensional coordinate data after the alteration, Z data and texture data are supplied to the GS 404. The GS 404 then performs drawing processing by executing rendering based on such altered two-dimensional coordinate data and Z data, and writing (drawing) the texture data serially in the RAM 405 (image memory, herein) as a memory. The texture data drawn herein are supplied to the monitor 18 after one frame of image completed by such drawing is encoded by the encoder 407, and displayed thereon as an image.

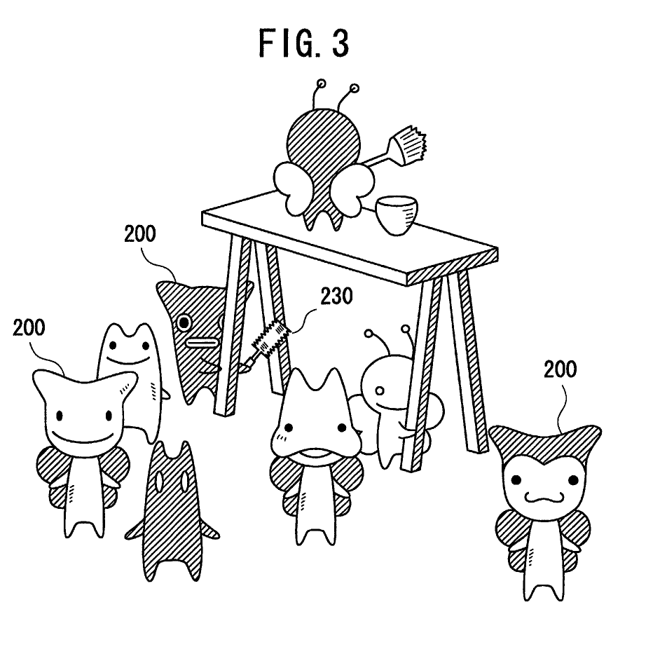

Next, characteristic functions of the entertainment system according to the present embodiment will be described referring to FIGS. 3 to 19.

A first function is such that generating a game character to be raised based on at least appearance and personality parameters entered according to the operational instruction from the user. For example as shown in FIG. 3, the game character 200 to be raised is such that enjoying various conversation with the user or playing with other game characters 200.

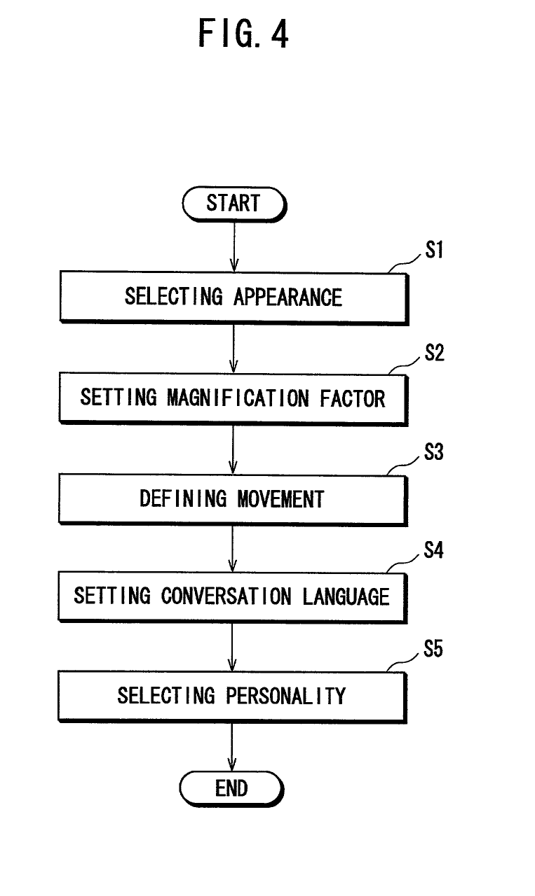

A method of generating the game character 200 will be explained referring to FIGS. 4 to 7.

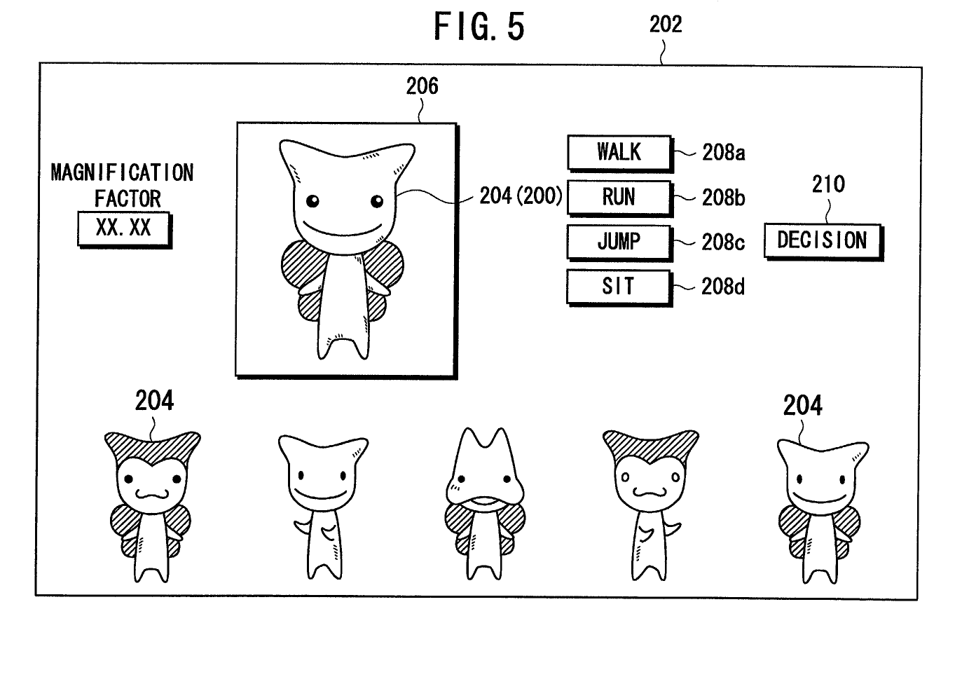

In step S1 in FIG. 4, the user selects an appearance of the game character 200 which he or she wants to raise. Such selection of the appearance is performed using an appearance selection screen 202 shown in FIG. 5. The appearance selection screen 202 includes a plurality of appearances 204 (ready-made appearances or user's original appearances), a window 206 for previewing the selected appearance 204 in an arbitrary magnification factor, and a plurality of motion selection icons 208a to 208d for defining several motions to be exhibited by such selected appearance 204.

The user first selects any one appearance 204 from a plurality of displayed appearances 204. The selected appearance 204 is shown in the window 206. By properly altering the magnification factor in step S2 in FIG. 4, the selected appearance 204 will be enlarged or shrunk corresponding with such magnification factor.

Next in step S3 in FIG. 4, the user confirms motion of the game character. The confirmation is enabled by operating (clicking) an arbitrary icon of a plurality of motion selection icons 208a to 208d displayed in the appearance selection screen 202.

For example, operation of the “Walk” icon 208a will result in motion display in which only the game character 200 having selected therefor the appearance 204 will walk. Such motion pattern of “Walk” is provided typically with four options, which can serially be toggled by operating such icon 208a. The user can determine a desired walking motion of the game character 200 by operating a Decision icon 210 when his or her favorite motion is displayed.

The user can also determine the individual motions of “Run”, “Jump” and “Sit” similarly by operating the corresponded icons 208b, 208c and 208d and by operating the “Decision” icon 210.

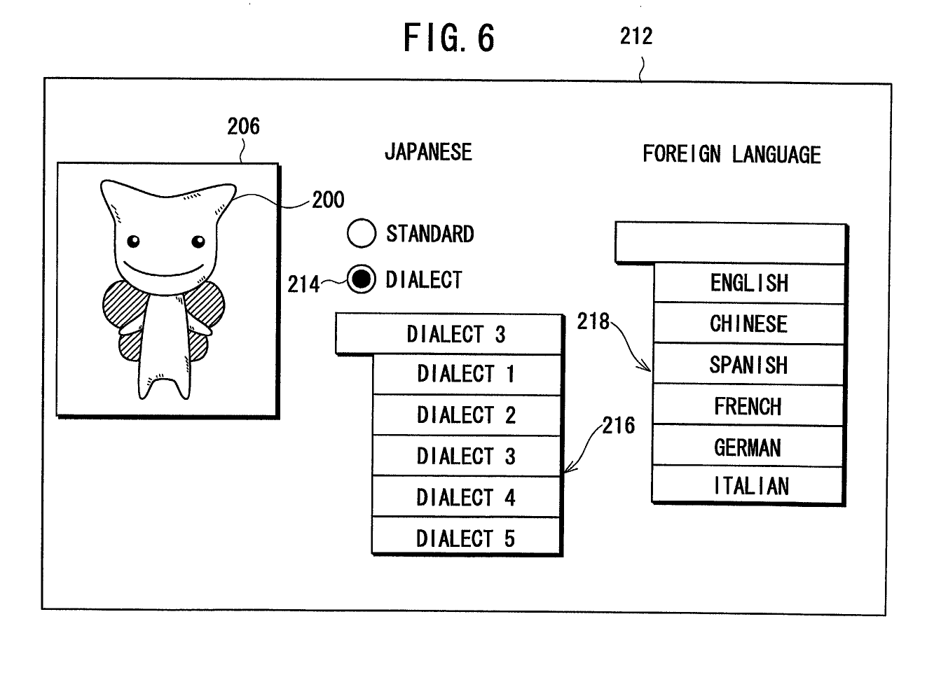

Next in step S4 in FIG. 4, the user sets a conversation language spoken by the game character 200. Such setting is accessible by displaying a language setting screen 212 shown in FIG. 6.

The language setting screen 212 is divided into columns for Japanese and foreign languages. The Japanese column is further divided into standard accent and dialect, and a selection mark 214 is displayed for either of which is selected by the user. When the dialect is selected, contents 216 thereof will appear. FIG. 6 shows an exemplary case in which the dialect and dialect 3 included therein were selected. On the other hand, the foreign language column is provided with content 218 of representative languages spoken by the game character 200.

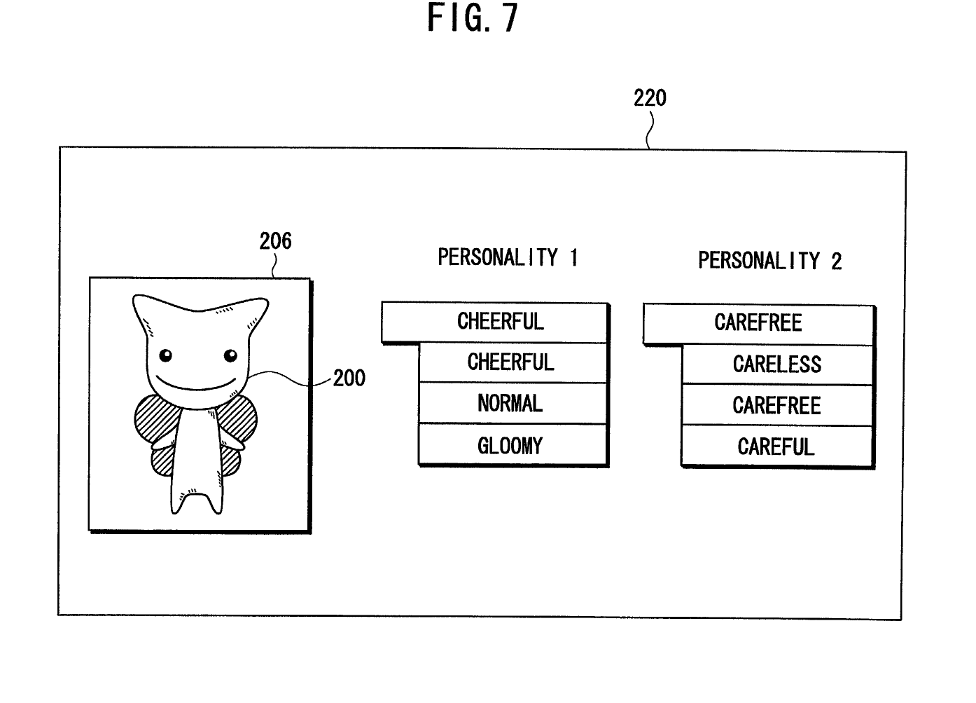

Next in step S5 in FIG. 4, the user defines a personality of the game character 200. Such setting is accessible by displaying a personality setting screen 220 shown in FIG. 7.

The personality setting screen 220 allows the user to set two types of the personality (personality 1 and personality 2). Personality 1 typically comprises “Cheerful”, “Normal” and “Gloomy”, and personality 2 typically comprises “Careless”, “Carefree” and “Careful”, where only one of the individual personalities is selectable. FIG. 7 shows an exemplary case in which “Cheerful” is selected as personality 1, and “Carefree” is selected as personality 2.

The character generation processing is completed when the personality setting for the game character ends in step S5.

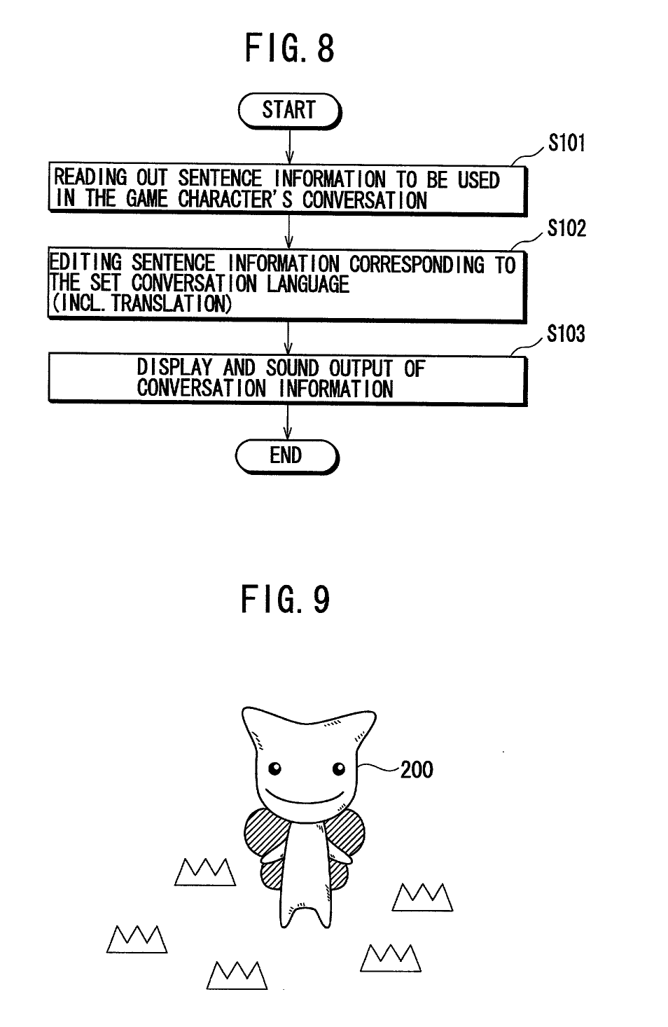

Conversation processing of the game character based on the foregoing conversation language proceeds as shown in FIG. 8.

In step S101 in FIG. 8, the entertainment device 12 reads out sentence information (keywords, etc.) spoken by the game character 200. The sentence information can be those extracted from information received via a network.

Thereafter in step S102, the entertainment device 12 edits the sentence information according to the set conversation language, to thereby generate conversation information. For the case a foreign language is selected, such editing includes translation. For the case Japanese is selected, the editing includes modification of the inflection or the like specific to the selected dialect.

Then in step S103, the entertainment device 12 displays the conversation information generated by such editing on the screen of the monitor 18. Sound output is concomitantly available from the sound producing system 412.

A second function is such that setting at least conducts of the game character 200 displayed on the monitor 18 according to a user's operational instruction associated with an event occurred when one or more game characters 200 displayed on the monitor 18 is to be raised.

The following paragraphs specifically describe user's processing during the raising of the generated game character 200, and in particular processing by which the conducts of the game character 200 vary depending on the user's response thereto.

The game character 200 generated depending on the parameter setting by the user tries to attract users attention by talking thereto or requesting a present. When the user friendly responses to the game character 200 or give some presents thereto, the game character grows up as a good fellow as shown in FIG. 9. Such raising of course results in upgraded personal ability of the game character 200 similarly to the conventional case, which is typified by swifter motion, larger body or improved level.

On the contrary, if the user does not respond to the talking of the game character 200 or does not give any presents, the game character grows up as a bad fellow as shown in FIG. 10.

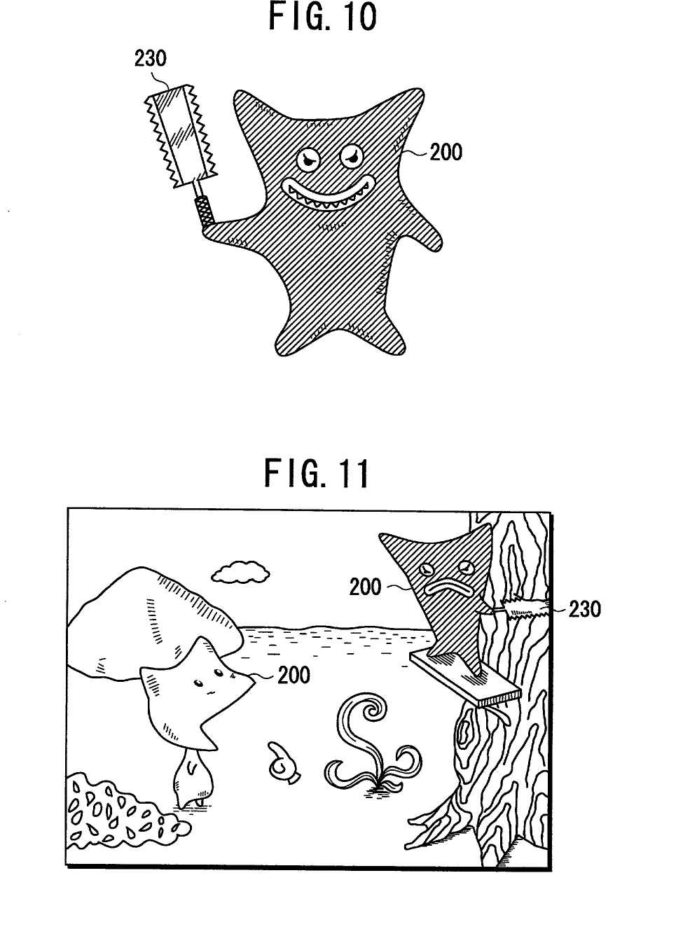

Briefly, difference between the game characters 200 grown up as a good fellow (simply referred to as a good character) and a bad fellow (simply referred to as a bad character) is such that the good character 200 acts friendly and talks much to the user, whereas the bad character 200 takes a hostile attitude toward the user and does mischief such as painting or destroying everything around with a saw 230 as shown in FIGS. 3 and 11.

Such motion patterns can be attained by previously arranging motion data file groups for the good character and bad character. The individual data file groups have a number of motion data files, and such motion data files are grouped by a plurality of appearances, and are assigned to every personality. For example, when a cheerful and careless personality is set, a motion corresponded to such personality and specific to the foregoing good character or bad character will be displayed.

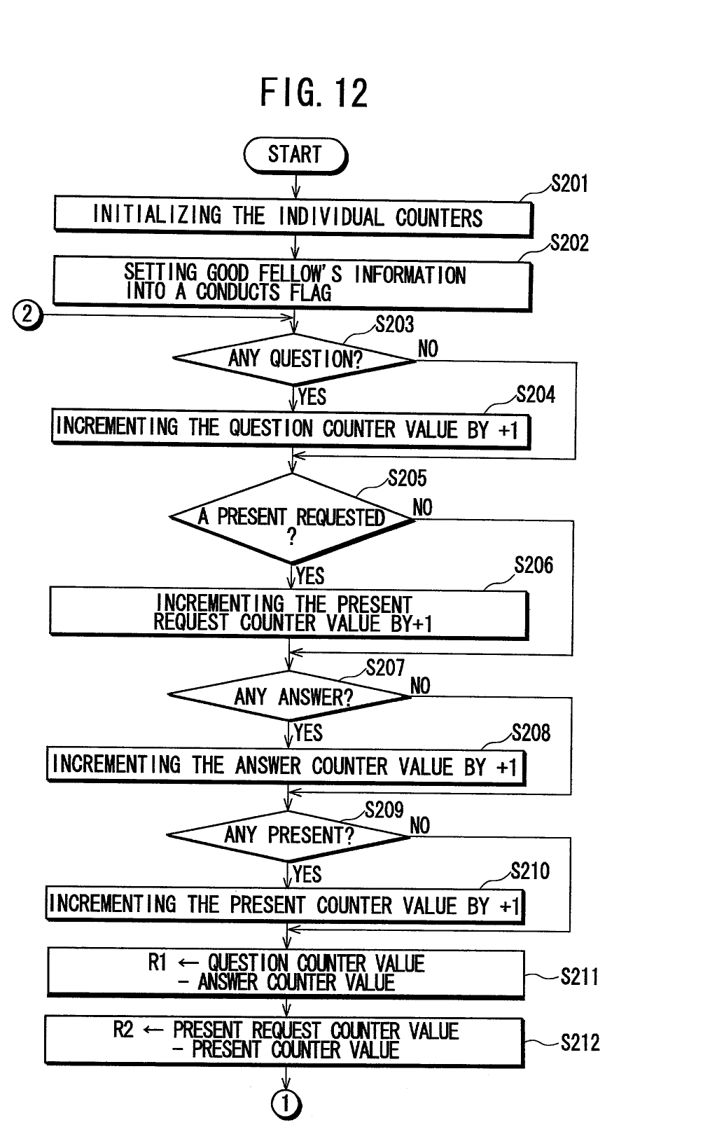

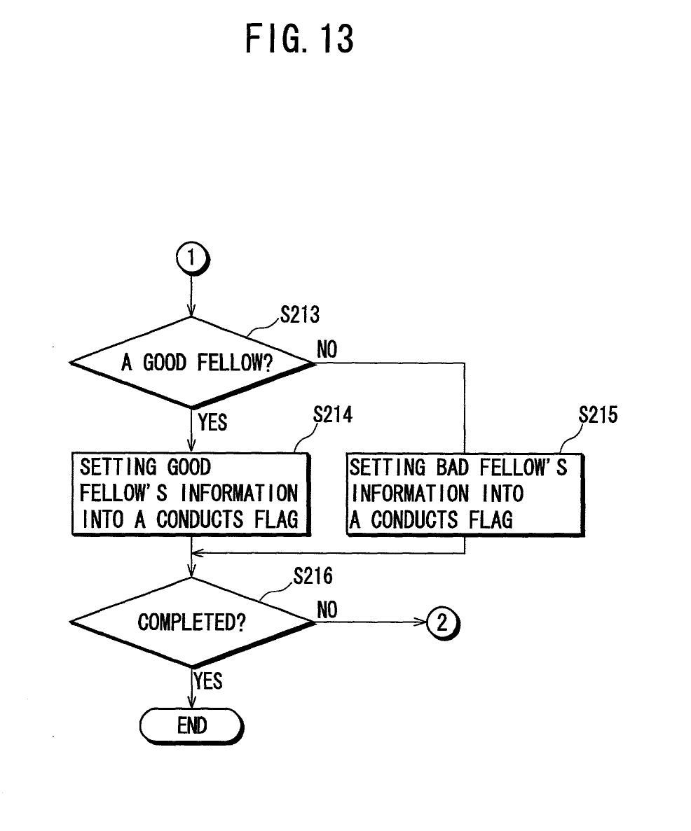

Processing during the raising of the game character 200 by the user will now be explained referring to flow charts in FIGS. 12 and 13.

First in step S201 in FIG. 12, the entertainment device 12 stores initial value “0” respectively into a question counter for counting number of times of asking question, a present request counter for counting number of times of requesting a present, an answer counter for counting number of times of answering the question, and a present counter for counting number of times of giving a present, to thereby initialize such question counter, present request counter, answer counter and present counter.

Next in step S202, the entertainment device 12 sets good character's information to a conduct flag. Then in step S203, the entertainment device 12 discriminates whether any question is submitted by the game character 200, and if yes, the process advances to step S204, where the entertainment device 12 increments the value of the question counter by +1.

Next, in step S205, the entertainment device 12 discriminates whether any request for a present is submitted by the game character 200, and if yes, the process advances to step S206, where the entertainment device 12 increments the value of the present request counter by +1.

Next, in step S207, the entertainment device 12 discriminates whether the user answered to the question of the game character 200, and if yes, the process step advances to step S208, where the entertainment device 12 increments the value of the answer counter by +1.

Next, in step S209, the entertainment device 12 discriminates whether a present was given in response to the present request of the game character 200, and if yes, the process step advances to step S210, where the entertainment device 12 increments the value of the present counter by +1.

Next, in step S211, the entertainment device 12 calculates difference between values of the question counter and the answer counter, which is followed by storing the result into register R1, and then in step S212, calculates difference between values of the present request counter and present counter, which is followed by storing the result into register R2.

Next, in step S213 in FIG. 13, the entertainment device 12 discriminates whether the game character 200 satisfies conditions of a good character. The discrimination is typically based on whether a value of the register R1 is smaller than a predetermined value “A”, and a value of the register R2 is smaller than a predetermined value “B”.

That is, in such exemplary case, the entertainment device 12 determines the game character 200 as a good character if number of times not answering the question of the game character 200 is smaller than the predetermined value “A”, and number of times not giving a present in response to the request from the game character 200 is smaller than the predetermined value “B”.

If the conditions for the good character are satisfied, the process advances to the next step S214, where the entertainment device 12 sets information expressing the good character to the conduct flag. On the other hand, if the conditions for the good character was not found to be satisfied, the process advances to step S215, where the entertainment device 12 sets information expressing the bad character to the conduct flag.

When the process in steps S214 or S215 is completed, the process then advances to step S216, where the entertainment device 12 discriminates whether the end request for the raising processing is issued or not. If no end request is detected, the process returns to step S203, where the entertainment device 12 repeats the processing of step S203 and thereafter.

Upon detection of the end request in step S216, the raising processing, in particular the discrimination of good and bad characters, comes to the end.

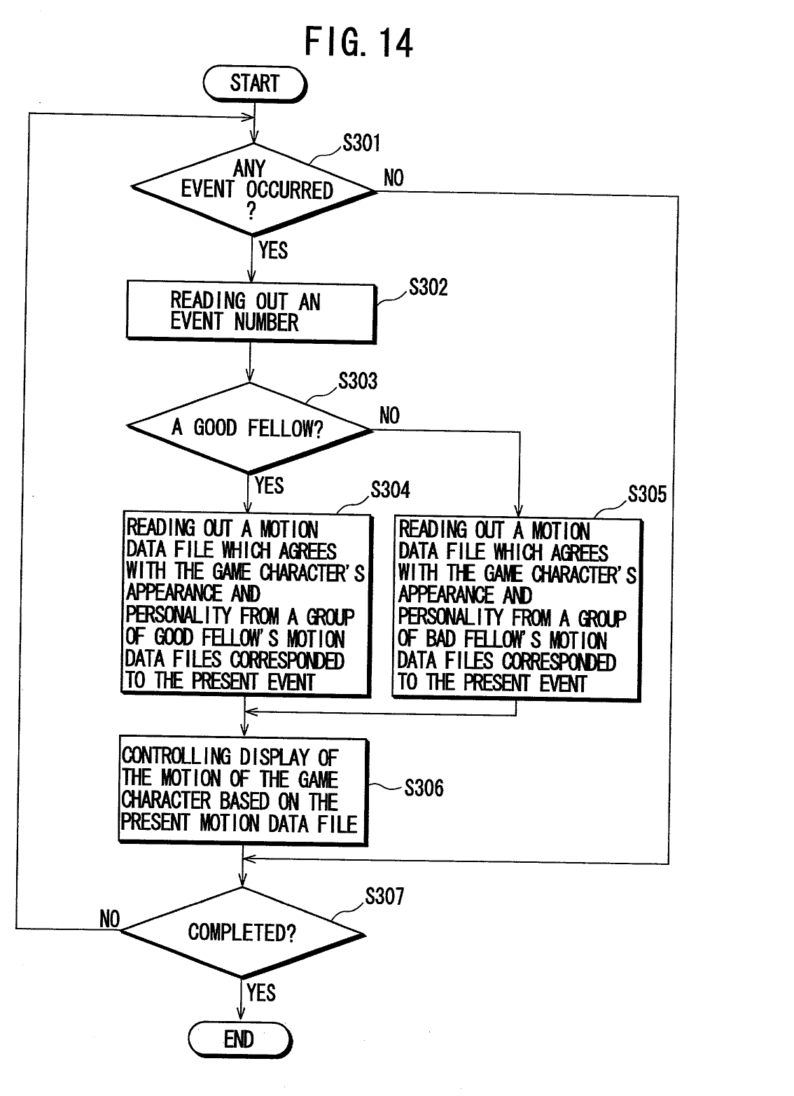

Next paragraphs will describe the processing for displaying motion of the game character 200 (motion display processing) referring to the flow chart shown in FIG. 14.

In step S301 in FIG. 14, the entertainment device 12 discriminates whether any event occurred or not. If some events were found to occur, the process advances to the next step S302, where the entertainment device 12 reads out the number of the generated event (event number).

Next in step S303, the entertainment device 12 discriminates whether the game character 200 is a good character or not. The discrimination is based on the information set into the conduct flag (information for expressing good or bad character).

If the game character 200 was found to be a good character, the process advances to the next step S304, where the entertainment device 12 reads out a motion data file which agrees with the set appearance and personality from the motion data file groups for the good character corresponded to the current event number.

On the other hand, if the game character 200 was found to be a bad character, the process advances to step S305, where the entertainment device 12 reads out a motion data file which agrees with the set appearance and personality from the motion data file groups for the bad character corresponded to the current event number.

Upon completion of the processing in step S304 or S305, the process advances to step S306, where the entertainment device 12 displays motion of the game character 200 based on such current motion data file.

Next, in step S307, the entertainment device 12 discriminates whether the end request for the motion display processing is issued or not. If no end request is detected, the process returns to step S301, where the entertainment device 12 repeats the processing of step S301 and thereafter.

Upon detection of the end request in step S307, the motion display processing comes to the end.

Now in such raising of the game character according to the operational instruction by the user, it is also possible to marry one game character 200 to another game character 200 so as to obtain a new game character 200A having an improved level.

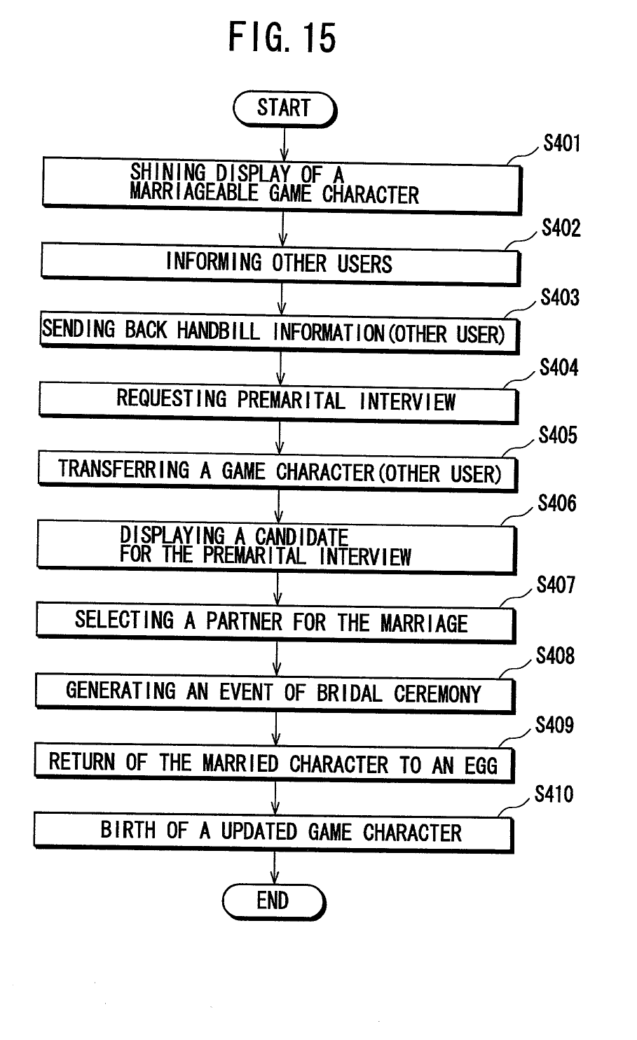

The processing for character's marriage will be described referring to FIGS. 15 to 19. First in step S401 in FIG. 15, the entertainment device 12 allows, from a plurality of game characters 200, one game character 200a that attained a marriageable age to shine. The marriageable age can be discriminated whether a predetermined time period (e.g., three months) has elapsed or not since the game character 200 was generated. Such flashing display of the game character 200a allows the user to recognize at a glance that which game character 200 attained a marriageable age.

Next in step S402 in FIG. 15, the entertainment device 12 announces to the other users through the network the presence of a game character 200a in the marriageable age. Such announcement may be e-mailed in a general manner, or may be transmitted in a form of image information (handbill information) having a handbill-like style with a portrait and profile of the game character. It is also allowable to use a special messenger character haunting among the users through the network.

Next in step S403, the other users select, from several game characters under the raising, one game character 200 for whom they want to arrange marriage, and then return to the sender, for example, image information (handbill information) having a handbill-like style with a portrait and profile of the game character as described in the above.

Next in step S404, the user observes the returned handbill information, selects desirable game characters 200, and then makes an offer of premarital interview to the users who are raising the selected game characters 200 by an e-mail or handbill information.

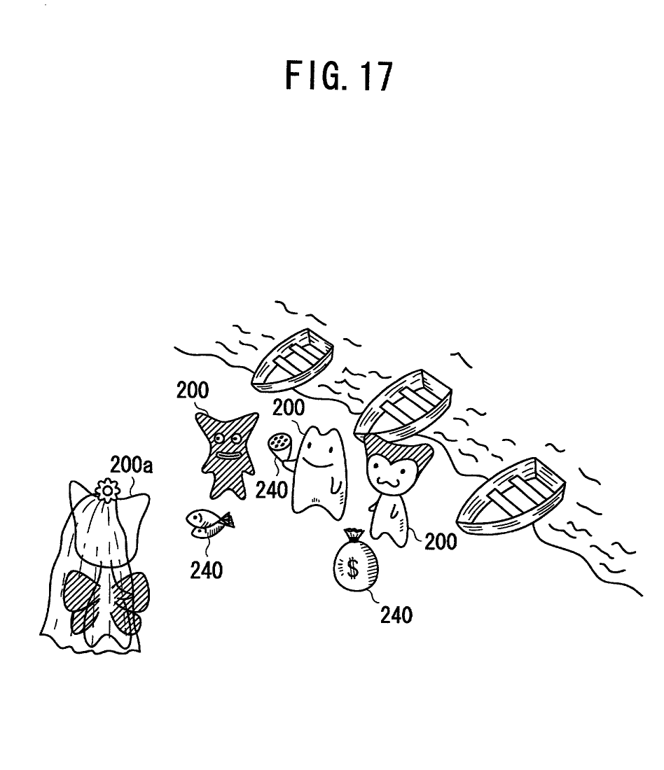

Next in step S405, the users who received the offer of the premarital interview transfer the respective selected game characters 200 under raising with tributes 240 (see FIG. 17). A practical processing is such that sending parameter information of the game characters 200 and numeral information of the tributes 240, rather than sending image information of the game characters 200.

Next in step S406, after being sent with the parameter information of the game characters 200 and the numeral information of the tributes 240 through the network, the entertainment device 12 generates game characters 200 identical to the game characters 200 to be interviewed based on the received parameter information, which are displayed on the monitor 18, and reads out the image information of the tributes 240 corresponded to the numeral information, which are also displayed on the monitor 18.

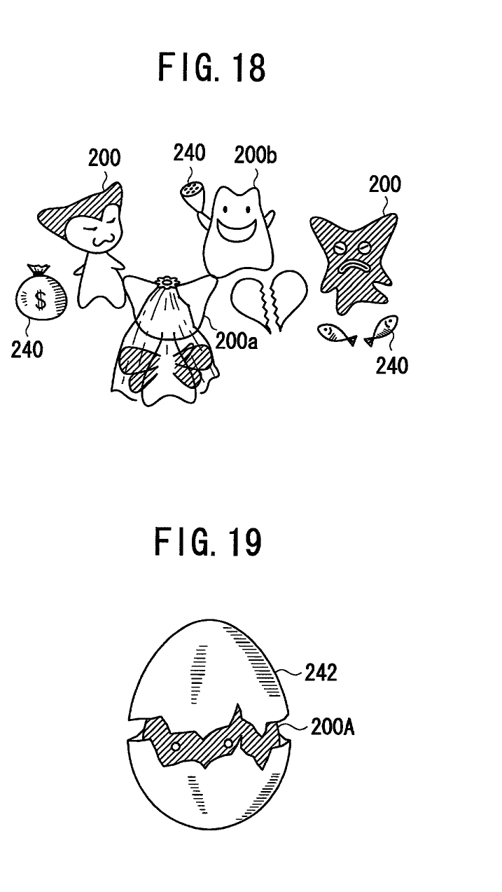

Next in step S407, the user requested the premarital interview selects either one of the game characters 200 desirable for the marriage from those appeared with the tributes 240 as shown in FIG. 18. Such selection may be effected by the user through pointing the desirable character 200 with the cursor (not shown) and clicking, or may be effected in a displayed scene in which the game character 200a in a marriageable age selects a game character 200b corresponded to a generated random number. It is also allowable to show a scene in which the unselected game characters 200 go back to where they were while acting as being disappointed.

Next in step S408, a bridal event occurs. It is also allowable to combine such event with another event in which a number of game characters 200 are displayed to bless the marriage.

Next in step S409, the entertainment device 12 displays a scene in which the married game characters 200a and 200b return to an egg and go back to the individual users. That is, the entertainment device 12 displays a scene in which the character 200a returns to the egg on the monitor 18 of the user who requested the premarital interview, and displays a scene in which the egg comes back on the monitor 18 of the user who sent the game character 200b.

Next in step S410, the entertainment device 12 displays a scene in which the egg 242 breaks and an upgraded game character 200A is born, as shown in FIG. 19. The event of marriage is completed in such stage.

As has been described in the above, the entertainment device 12 according to the present embodiment can generate the game character 200 by the game character generation processing based on at least on the appearance and personality parameters of such game character 200 entered according to the user's operational instruction.

This allows the user to define by himself or herself basic parameters (appearance, personality, etc.) of the game character 200 to be raised, and to enjoy various raising patterns even if the same game character 200 is to be raised.

In particular, since the system is designed so as to display the appearance selection screen 202 in which one appearance 204 selected from a plurality of appearances 204 is shown, the motion selection icons 208a to 208d for defining motion for the selected appearance 204, the personality setting screen 220 for setting personality of the game character 200 having the appearance 204 already selected, and the language setting screen 212 for setting conversation language for such game character 200, so that the user can readily set the basic parameters of the game character 200 to be raised, and can readily generate various game characters 200.

In the character raising processing for raising one or more characters 200 displayed on the monitor 18 in the present embodiment, at least conducts of such game character 200 can be set according to the operational instruction by the user in association to a generated event.

This allows the user to enjoy, not only changes in a ratio of ability improvement, but also an unprecedented raising pattern in which a game character 200 can become a good or bad fellow depending on the raising method.

In particular, since the system is designed so as to generate an event of virtual marriage of the game characters 200 under raising by the user and another user via network, so that the individual users can feel more familiar to their game characters under raising and can enjoy conversation with such game characters.

In addition, conducts (a good fellow or a bad fellow) and/or marriage condition such as marriageable age and matching of the game character can be modified based on appearance and personality parameters of the game character set by the user.

This allows the user to generate much variety of game characters. And further, by making the rule that the character tends to be a bad fellow if the user set the parameters to a game character which is considered preferable, for example, it becomes possible to let the user set the parameters more carefully and realize a high gameness.

According to the present embodiment, the user can enjoy a raising game without loosing the interest.

The embodiment described in the above is only part of the examples of the present invention. It is therefore to be understood that the recording medium, program, program execution system and program execution device of the present invention may be practiced in any modifications depending on the design or the like otherwise than as specifically described herein without departing from the scope and the technical spirit thereof.

What is claimed is:

1. A recording medium having recorded therein a program and data used on a program execution system which comprises a program execution device for executing various programs, at least one operational device for allowing a user to enter an operation request as an operational instruction into the program execution device, and a display device for displaying an image output from the program execution device;
wherein the program comprises a step of generating a virtual game character based at least on appearance and personality parameters of the virtual game character entered according to the operational instruction by the user.

2. The recording medium according to claim 1, wherein the step for generating the virtual game character comprises a step of displaying an appearance selection screen for displaying one appearance selected from a plurality of appearances, and motion selection icons for allowing the virtual game character having a selected appearance to move.

3. The recording medium according to claim 1, wherein the program further comprises a step of displaying a personality setting screen for the virtual game character for which at least the appearance was selected.

4. The recording medium according to claim 1, wherein the program further comprises a step of displaying a screen for setting a conversation language for the virtual game character for which at least the appearance was selected.

5. A recording medium having recorded therein a program and data used on a program execution system which comprises a program execution device for executing various programs, at least one operational device for allowing a user to enter an operation request as an operational instruction into the program execution device, and a display device for displaying an image output from the program execution device;
wherein the program comprises a step of raising one or more virtual game characters displayed on the display device; and
the character raising step comprises a step of setting at least conducts of the virtual game character displayed on the display device based on the operational instruction by the user corresponding to a generated event.

6. The recording medium according to claim 5, wherein the character raising step further comprises a step of determining motion of the virtual game character based on the set conduct information.

7. The recording medium according to claim 5, wherein the character raising step further comprises a step of generating an event for virtually marrying, through a network, the virtual game character under raising by the user to another virtual game character under raising by another user.

8. The recording medium according to claim 7, wherein the step for generating an event comprises a step of informing the user of a virtual game character who attained the marriageable age from one or more virtual game characters.

9. The recording medium according to claim 7, wherein the step for generating an event comprises a step of generating an event for arranging a premarital interview between the virtual game character raised by the user and another virtual game character raised by another user.

10. A computer-readable and -executable program used on a program execution system which comprising a program execution device for executing various programs, at least one operational device for allowing a user to enter an operation request into the program execution device, and a display device for displaying an image output from the program execution device;
wherein the program comprises a step of generating a virtual game character based at least on appearance and personality parameters of the virtual game character entered according to an operational instruction by the user.

11. A computer-readable and -executable program used on a program execution system which comprises a program execution device for executing various programs, at least one operational device for allowing a user to enter an operation request into the program execution device, and a display device for displaying an image output from the program execution device;
wherein the program comprises a step of raising one or more virtual game characters displayed on the display device; and
the character raising step comprises a step of setting at least conducts of the virtual game character displayed on the display device based on an operational instruction by the user corresponding to a generated event.

12. A program execution system comprising a program execution device for executing various programs, at least one operational device for allowing a user to enter an operation request as an operational instruction into the program execution device, and a display device for displaying an image output from the program execution device;
wherein the program to be executed on the program execution device comprises a step of generating a virtual game character based at least on appearance and personality parameters of the virtual game character entered according to the operational instruction by the user.

13. A program execution system comprising a program execution device for executing various programs, at least one operational device for allowing a user to enter an operation request as an operational instruction into the program execution device, and a display device for displaying an image output from the program execution device;
wherein the program comprises a step of raising one or more virtual game characters displayed on the display device; and
the character raising step comprises a step of setting at least conducts of the virtual game character displayed on the display device based on the operational instruction by the user corresponding to a generated event.

14. A program execution device for executing various programs, to which an operational device for outputting user's operation request and a display device for displaying images are connectable;
wherein the program comprises a step of generating a virtual game character based at least on appearance and personality parameters of the virtual game character entered according to an operational instruction by such user.

15. A program execution device for executing various programs, to which an operational device for outputting user's operation request and a display device for displaying images are connectable;
wherein the program comprises a step of raising one or more virtual game characters displayed on the display device; and
the character raising step comprises a step of setting at least conducts of the virtual game character displayed on the display device based on an operational instruction by the user corresponding to a generated event.
